(19) United States
(12) Patent Application Publication
(10) Pub. No.: US 2015/0112685 A1
(43) Pub. Date: Apr. 23, 2015

(54) SPEECH RECOGNITION METHOD AND ELECTRONIC APPARATUS USING THE METHOD

(71) Applicant: VIA Technologies, Inc., New Taipei City (TW)

(72) Inventors: Guo-Feng Zhang, Shanghai (CN); Yi-Fei Zhu, Shanghai (CN)

(21) Appl. No.: 14/503,422

(22) Filed: Oct. 1, 2014

(30) Foreign Application Priority Data
Oct. 18, 2013 (CN) 201310489578.3

(51) Int. Cl. G10L 15/18; G10L 15/02

(52) U.S. Cl. CPC G10L 15/18; G10L 15/02
USPC 704/257

(57) ABSTRACT

A speech recognition method and an electronic apparatus using the method are provided. In the method, a feature vector obtained from a speech signal is inputted to a plurality of speech recognition modules, and a plurality of string probabilities and a plurality of candidate strings are obtained from the speech recognition modules respectively. The candidate string corresponding to the largest one of the plurality of string probabilities is selected as a recognition result of the speech signal.

### CROSS-REFERENCE TO RELATED APPLICATION

This application claims the priority benefit of China application serial no. 201310489578.3, filed on Oct. 18, 2013. The entirety of the above-mentioned patent application is hereby incorporated by reference herein and made a part of this specification.

### BACKGROUND OF THE INVENTION

1. Field of the Invention

The invention relates to a speech recognition technique, and more particularly, relates to a speech recognition method for recognizing different languages and an electronic apparatus thereof.

2. Description of Related Art

Speech recognition is no doubt a popular research and business topic. Generally, speech recognition is to extract feature parameters from an inputted speech and then compare the feature parameters with samples in the database to find and extract the sample that has less dissimilarity with respect to the input.

One common method is to collect speech corpus (e.g. recorded human speeches) and manually label the speech corpus (i.e. annotating each speech with a corresponding text), and then use the corpus to train the acoustic model and acoustic dictionary. The acoustic model is a kind of statistical classifier. At present the Gaussian Mixture Model is often used to classify the inputted speech into basic phones. Phones are basic phonetics and transition between phones that constitute the language under recognition. In addition, there are non-speech phones, such as coughs. Generally, the acoustic dictionary is composed of individual words of the language under recognition, and the individual words are composed of sounds outputted by the acoustic model through the Hidden Markov Model (HMM).

However, the current method faces the following problems. Problem 1: if nonstandard pronunciation (e.g. unclear retroflex, unclear front and back nasals, etc.) of the user is inputted to the acoustic model, fuzziness of the acoustic model increases. For example, in order to cope with nonstandard pronunciation, the acoustic model may output “ing” that has higher probability for the phonetic “in”, which leads to the increase of the overall error rate. Problem 2: due to different pronunciation habits in different regions, nonstandard pronunciation may vary, which further increases the fuzziness of the acoustic model and reduces the recognition accuracy. Problem 3: dialects (e.g. standard Mandarin, Shanghainese, Cantonese, Minnan, etc.) cannot be recognized.

### SUMMARY OF THE INVENTION

The invention provides a speech recognition method and an electronic apparatus thereof for automatically recognizing a language corresponding to a speech signal.

The speech recognition method of the invention is adapted for the electronic apparatus. The speech recognition method includes: obtaining a feature vector from a speech signal; inputting the feature vector to a plurality of speech recognition modules and obtaining a plurality of string probabilities and a plurality of candidate strings from the speech recognition modules respectively, wherein the speech recognition modules respectively correspond to a plurality of languages; and selecting the candidate string corresponding to the largest one of the string probabilities as a recognition result of the speech signal.

In an embodiment of the invention, the step of inputting the feature vector to the speech recognition modules and obtaining the string probabilities and the candidate strings from the speech recognition modules respectively includes: inputting the feature vector to an acoustic model of each of the speech recognition modules and obtaining a candidate phrase corresponding to each of the languages based on a corresponding acoustic dictionary; and inputting the candidate phrase to a language model of each of the speech recognition modules to obtain the candidate strings and the string probabilities corresponding to the languages.

In an embodiment of the invention, the speech recognition method further includes: obtaining the acoustic model and the acoustic dictionary through training based on a speech database corresponding to each of the languages; and obtaining the language model through training based on a text corpus corresponding to each of the languages.

In an embodiment of the invention, the speech recognition method further includes: receiving the speech signal by an input unit.

In an embodiment of the invention, the step of obtaining the feature vector from the speech signal includes: dividing the speech signal into a plurality of frames; and obtaining a plurality of feature parameters from each of the frames to obtain the feature vector.

The invention further provides an electronic apparatus, which includes an input unit, a storage unit, and a processing unit. The input unit receives a speech signal. The storage unit stores a plurality of code snippets. The processing unit is coupled to the input unit and the storage unit. The processing unit drives a plurality of speech recognition modules corresponding to a plurality of languages by the code snippets and executes: obtaining a feature vector from the speech signal and inputting the feature vector to the speech recognition modules to obtain a plurality of string probabilities and a plurality of candidate strings from the speech recognition modules respectively; and selecting the candidate string corresponding to the largest one of the string probabilities.

In an embodiment of the invention, the electronic apparatus further includes an output unit. The output unit is used to output the candidate string corresponding to the largest one of the string probabilities.

Based on the above, the invention respectively decodes the speech signal in different speech recognition modules so as to obtain output of the candidate string corresponding each speech recognition module and the string probability of the candidate string. Moreover, the candidate string corresponding to the largest string probability is selected as the recognition result of the speech signal. Accordingly, the language corresponding to the speech signal can be automatically recognized without the user's manual selection of the language of the speech recognition module.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a block diagram of an electronic apparatus according to an embodiment of the invention.

FIG. 1B is a block diagram of an electronic apparatus according to another embodiment of the invention.

FIG. 2 is a schematic diagram of a speech recognition module according to an embodiment of the invention.

FIG. 3 is a flowchart of a speech recognition method according to an embodiment of the invention.

FIG. 4 is a schematic diagram of a multi-language model according to an embodiment of the invention.

### DESCRIPTION OF THE EMBODIMENTS

The following problem is common in the conventional speech recognition method; namely, the accuracy of a recognition rate may be affected by fuzzy sounds in dialects of different regions, pronunciation habits of different users, or different languages. Thus, the invention provides a speech recognition method and an electronic apparatus thereof for improving the accuracy of recognition rate on the basis of the original speech recognition. In order to make this disclosure of the invention more comprehensible, embodiments are described below as examples to prove that the invention can actually be realized.

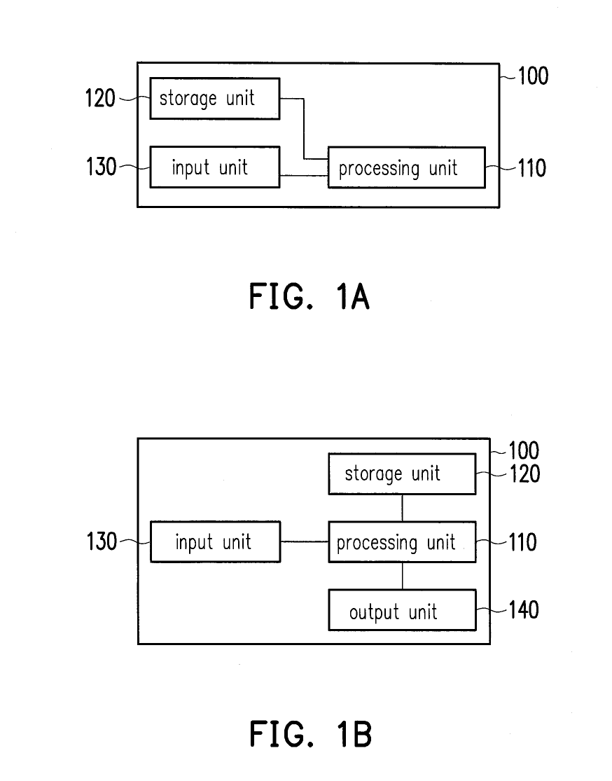

FIG. 1A is a block diagram of an electronic apparatus according to an embodiment of the invention. With reference to FIG. 1A, an electronic apparatus 100 includes a processing unit 110, a storage unit 120, and an input unit 130. The electronic apparatus 100 is for example a device having a computation function, such as a smart phone, a personal digital assistant (PDA), a tablet computer, a laptop computer, a desktop computer, or a car computer, etc.

The processing unit 110 is coupled to the storage unit 120 and the input unit 130. For instance, the processing unit 110 is a central processing unit (CPU) or a microprocessor, which is used for executing hardware or firmware of the electronic apparatus 100 or processing data of software. The storage unit 120 is a non-volatile memory (NVM), a dynamic random access memory (DRAM), or a static random access memory (SRAM), etc., for example.

For the electronic apparatus 100 that realizes a speech recognition method by a code, the storage unit 120 stores a plurality of code snippets therein. The code snippets are executed by the processing unit 110 after being installed. The code snippets include a plurality of commands, by which the processing unit 110 executes a plurality of steps of the speech recognition method. In this embodiment, the electronic apparatus 100 includes only one processing unit 110. However, in other embodiments, the electronic apparatus 100 may include a plurality of processing units used for executing the installed code snippets.

The input unit 130 receives a speech signal. For example, the input unit 130 is a microphone that receives an analog speech signal from a user and converts the analog speech signal to a digital speech signal to be transmitted to the processing unit 110.

More specifically, the processing unit 110 drives a plurality of speech recognition modules corresponding to various speeches by the code snippets and executes the following steps: obtaining a feature vector from the speech signal and inputting the feature vector to the speech recognition modules to obtain a plurality of string probabilities and a plurality of candidate strings from the speech recognition modules respectively; and selecting the candidate string corresponding to the largest one of the string probabilities.

Furthermore, in other embodiments, the electronic apparatus 100 may further include an output unit. For example, FIG. 1B is a block diagram of an electronic apparatus according to another embodiment of the invention. With reference to FIG. 1B, the electronic apparatus 100 includes a processing unit 110, a storage unit 120, an input unit 130, and an output unit 140. The processing unit 110 is coupled to the storage unit 120, the input unit 130, and the output unit 140. Details of the processing unit 110, the storage unit 120, and the input unit 130 have been described above and thus will not be repeated hereinafter.

The output unit 140 is for example a display unit, such as a cathode ray tube (CRT) display, a liquid crystal display (LCD), a plasma display, or a touch display, etc., for displaying the candidate string corresponding to the largest one of the obtained string probabilities. Alternatively, the output unit 140 may be a speaker for playing the candidate string corresponding to the largest one of the obtained string probabilities.

In this embodiment, different speech recognition modules are established for different languages or dialects. That is to say, an acoustic model and a language model are respectively established for each language or dialect.

The acoustic model is one of the most important parts of the speech recognition modules. Generally, the acoustic model may be established using a Hidden Markov Model (HMM). The language model mainly utilizes a probability statistical method to reveal the inherent statistical regularity of a language unit, wherein N-Gram is widely used for its simplicity and effectiveness.

An embodiment is illustrated below.

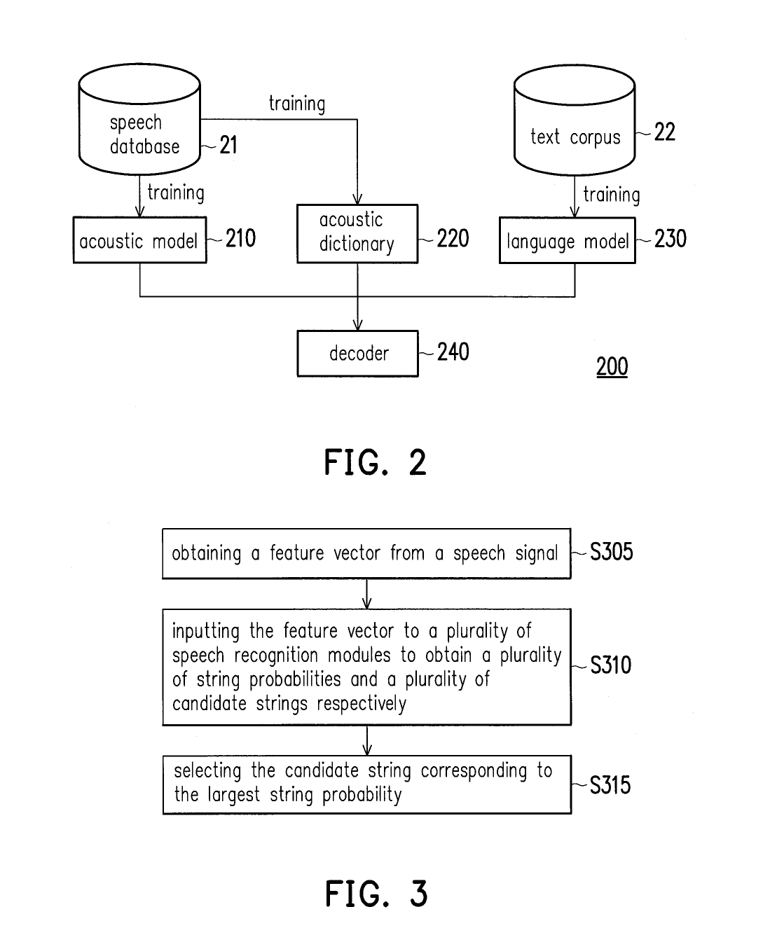

FIG. 2 is a schematic diagram of a speech recognition module according to an embodiment of the invention. With reference to FIG. 2, a speech recognition module 200 mainly includes an acoustic model 210, an acoustic dictionary 220, a language model 230, and a decoder 240.

The acoustic model 210 and the acoustic dictionary 220 are obtained through training of a speech database 21, and the language model 230 is obtained through training of a text corpus 22.

More specifically, mostly, the acoustic model 210 is modeled based on a first-order HMM. The acoustic dictionary 220 includes vocabulary and pronunciation thereof that can be processed by the speech recognition module 200. The language model 230 is modeled for a language to which the speech recognition module 200 is directed. For example, the language model 230 is a design concept based on a history-based Model, that is, to gather statistics of the relationship between a series of previous events and an upcoming event according to a rule of thumb. The decoder 240 is a core of the speech recognition module 200 for searching a candidate string that may be outputted with the largest probability with respect to the inputted speech signal according to the acoustic model 210, the acoustic dictionary 220, and the language model 230.

For example, a corresponding phone or syllable is obtained using the acoustic model 210, and then a corresponding word or phrase is obtained using the acoustic dictionary 220. Following that, the language model 230 determines the probability of a series of words becoming a sentence.

Below steps of a speech recognition method are explained with reference to the electronic apparatus 100 of FIG. 1A. FIG. 3 is a flowchart of the speech recognition method according to an embodiment of the invention. With reference to FIG. 1A and FIG. 3, in Step S305, the processing unit 110 obtains a feature vector from a speech signal.

For example, an analog speech signal is converted to a digital speech signal, and the speech signal is divided into a plurality of frames, among which any two adjacent frames may have an overlapping region. Thereafter, a feature parameter is extracted from each frame to obtain one feature vector. For example, Mel-frequency Cepstral Coefficients (MFCC) may be used to extract 36 feature parameters from the frames to obtain a 36-dimensional feature vector.

Next, in Step S310, the processing unit 110 inputs the feature vector to a plurality of speech recognition modules to obtain a plurality of string probabilities and a plurality of candidate strings respectively. More specifically, the feature vector is inputted to the acoustic model of each speech recognition module, so as to obtain the candidate phrases corresponding to various languages based on the corresponding acoustic dictionaries. Then, the candidate phrases of various languages are inputted to the language model of each speech recognition module to obtain the candidate strings and string probabilities corresponding to various languages.

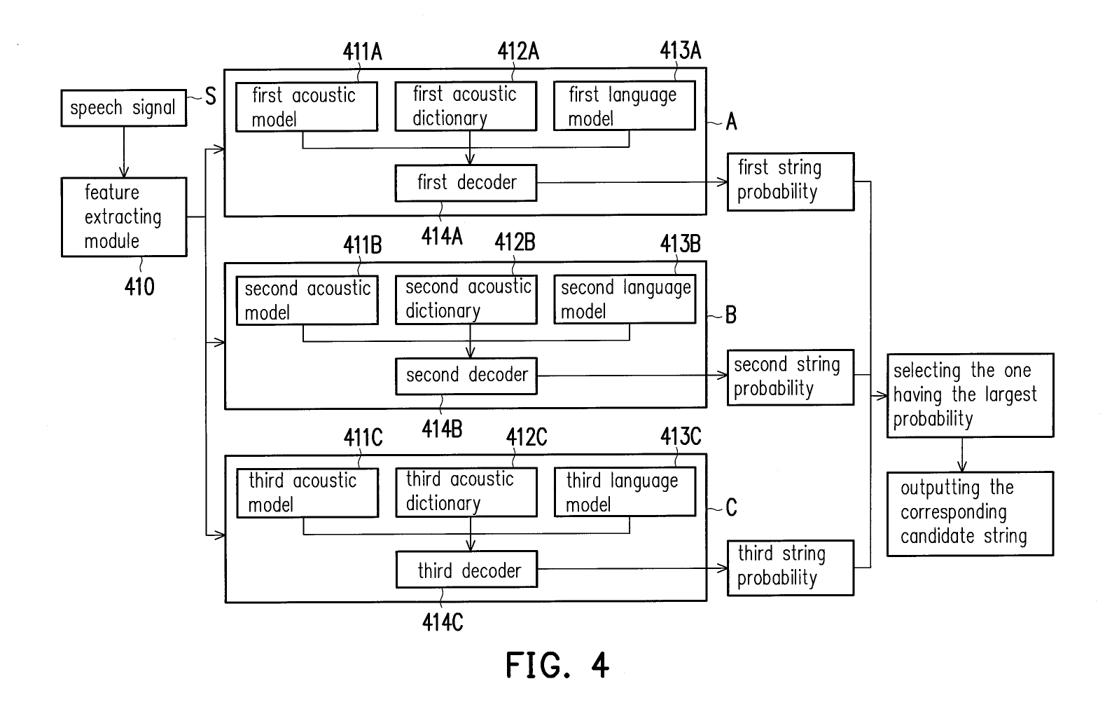

For example, FIG. 4 is a schematic diagram of a multi-language model according to an embodiment of the invention. This embodiment illustrates three languages as examples; however, in other embodiments, the number of the languages may be two or more than three.

With reference to FIG. 4, in this embodiment, speech recognition modules A, B, and C are provided for three languages. For instance, the speech recognition module A is configured to recognize standard Mandarin, the speech recognition module B is configured to recognize Cantonese, and the speech recognition module C is configured to recognize Minnan dialect. Here, a speech signal S that is received is inputted to a feature extracting module 410 to obtain a feature vector of a plurality of frames.

The speech recognition module A includes a first acoustic model 411A, a first acoustic dictionary 412A, a first language model 413A, and a first decoder 414A. The first acoustic model 411A and the first acoustic dictionary 412A are obtained through training of a speech database of standard Mandarin, and the first language model 413A is obtained through training of a text corpus of standard Mandarin.

The speech recognition module B includes a second acoustic model 411B, a second acoustic dictionary 412B, a second language model 413B, and a second decoder 414B. The second acoustic model 411B and the second acoustic dictionary 412B are obtained through training of a speech database of Cantonese, and the second language model 413B is obtained through training of a text corpus of Cantonese.

The speech recognition module C includes a third acoustic model 411C, a third acoustic dictionary 412C, a third language model 413C, and a third decoder 414C. The third acoustic model 411C and the third acoustic dictionary 412C are obtained through training of a speech database of Minnan dialect, and the third language model 413C is obtained through training of a text corpus of Minnan dialect.

Next, the feature vector is respectively inputted to the speech recognition modules A, B, and C for the speech recognition module A to obtain a first candidate string SA and a first string probability PA thereof; for the speech recognition module B to obtain a second candidate string SB and a second string probability PB thereof; and for the speech recognition module C to obtain a third candidate string SC and a third string probability PC thereof.

That is, through each speech recognition module, the candidate string that has the highest probability with respect to the speech signal S in the acoustic models and the language models of the various languages is recognized.

Thereafter, in Step S315, the processing unit 110 selects the candidate string corresponding to the largest string probability. Referring to FIG. 4, it is given that the first string probability PA, the second string probability PB, and the third string probability PC are 90%, 20%, and 15% respectively. Thus, the processing unit 110 selects the first candidate string SA corresponding to the first string probability PA (90%) as a recognition result of the speech signal. In addition, the selected candidate string, e.g. the first candidate string SA, may be further outputted to the output unit 140 as shown in FIG. 1B.

To sum up, for different languages or dialects, different acoustic models and language models are established for training respectively. The inputted speech signal is respectively decoded in different acoustic models and language models, and the decoding results are used not only to obtain output of the candidate string corresponding to each language model but also to obtain the probability of the candidate string. Thus, with the multi-language model, the candidate string having the largest probability is selected and outputted as the recognition result of the speech signal. In comparison with the conventional method, the independent language models used by the invention are accurate and do not cause the problem of language confusion. Moreover, the conversion from sound to text is performed correctly, and the type of the language or dialect can be known as well. The above is conducive to the subsequent machine voice conversation, e.g. directly outputting a reply in Cantonese to a Cantonese input. In addition, in the case that a new language or dialect is introduced, no confusion occurs to the original models.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A speech recognition method adapted for an electronic apparatus, the speech recognition method comprising:
obtaining a feature vector from a speech signal;
inputting the feature vector to a plurality of speech recognition modules and obtaining a plurality of string probabilities and a plurality of candidate strings from the plurality of speech recognition modules respectively, wherein the plurality of speech recognition modules respectively correspond to a plurality of languages; and
selecting the candidate string corresponding to the largest one of the plurality of string probabilities as a recognition result of the speech signal.

2. The speech recognition method according to claim 1, wherein the step of inputting the feature vector to the plurality of speech recognition modules and obtaining the plurality of string probabilities and the plurality of candidate strings from the plurality of speech recognition modules respectively comprises:
inputting the feature vector to an acoustic model of each of the plurality of speech recognition modules and obtaining a candidate phrase corresponding to each of the plurality of languages based on a corresponding acoustic dictionary; and
inputting the candidate phrase to a language model of each of the plurality of speech recognition modules to obtain the plurality of candidate strings and the plurality of string probabilities corresponding to the plurality of languages.

3. The speech recognition method according to claim 2, further comprising:
obtaining the acoustic model and the acoustic dictionary through training based on a speech database corresponding to each of the plurality of languages; and
obtaining the language model through training based on a text corpus corresponding to each of the plurality of languages.

4. The speech recognition method according to claim 1, further comprising:
receiving the speech signal by an input unit.

5. The speech recognition method according to claim 1, wherein the step of obtaining the feature vector from the speech signal comprises:
dividing the speech signal into a plurality of frames; and
obtaining a plurality of feature parameters from each of the plurality of frames to obtain the feature vector.

6. An electronic apparatus, comprising:
a processing unit;
a storage unit coupled to the processing unit and storing a plurality of code snippets to be executed by the processing unit; and
an input unit coupled to the processing unit and receiving a speech signal;
wherein the processing unit drives a plurality of speech recognition modules corresponding to a plurality of languages by the code snippets and executes: obtaining a feature vector from the speech signal and inputting the feature vector to the plurality of speech recognition modules to obtain a plurality of string probabilities and a plurality of candidate strings from the plurality of speech recognition modules respectively; and
selecting the candidate string corresponding to the largest one of the plurality of string probabilities.

7. The electronic apparatus according to claim 6, wherein the processing unit inputs the feature vector to an acoustic model of each of the plurality of speech recognition modules and obtains a candidate phrase corresponding to each of the plurality of languages based on a corresponding acoustic dictionary; and inputs the candidate phrase to a language model of each of the plurality of speech recognition modules to obtain the plurality of candidate strings and the plurality of string probabilities corresponding to the plurality of languages.

8. The electronic apparatus according to claim 7, wherein the processing unit obtains the acoustic model and the acoustic dictionary through training based on a speech database corresponding to each of the plurality of languages; and obtains the language model through training based on a text corpus corresponding to each of the plurality of languages.

9. The electronic apparatus according to claim 6, wherein the processing unit drives a feature extracting module by the code snippets and executes: dividing the speech signal into a plurality of frames and obtaining a plurality of feature parameters from each of the plurality of frames to obtain the feature vector.

10. The electronic apparatus according to claim 6, further comprising:
an output unit outputting the candidate string corresponding to the largest one of the plurality of string probabilities.
